(19) United States
(12) Patent Application Publication
(10) Pub. No.: US 2023/0264925 A1
(43) Pub. Date: Aug. 24, 2023

(54) Collapsible Gate

(71) Applicant: Rock Run Industries, LLC, Millersburg, IN (US)

(72) Inventor: Freeman Dale Schlabach, Millersburg, IN (US)

(21) Appl. No.: 17/678,711

(22) Filed: Feb. 23, 2022

(51) Int. Cl. B66B 13/30; E06B 11/02

(52) U.S. Cl. CPC B66B 13/303; E06B 11/025; E05Y 2900/40; E05Y 2201/404

(57) ABSTRACT

A collapsible gate includes a first side column, a second side column, a collapsible barrier assembly, a receiver, and a powertrain. The collapsible barrier assembly is disposed between the first and second side columns. The collapsible barrier is configured to transition between a collapsed position and a raised position. The receiver is disposed between the first side column and the second side column and is configured to receive at least a portion of the collapsible barrier assembly when it is in the collapsed position. The receiver has a first end coupled to the first lower portion of the side column and an opposite second end coupled to the second lower portion of the second side column. The powertrain is configured to transmit mechanical power to the collapsible barrier assembly to facilitate transitioning the collapsible barrier assembly between the collapsed position and the raised position.

### FIELD OF THE INVENTION

This invention relates generally to gates, and more particularly to powered gates. Even more particularly, the invention relates to powered safety gates.

### DESCRIPTION OF THE BACKGROUND ART

Factories and other manufacturing facilities commonly employ mezzanines as elevated workspaces. For example, products can move down an assembly line adjacent an elevated platform (e.g., a mezzanine), wherefrom workers can perform assembly operations on the products. Such mezzanines typically include guard rails disposed around the outer edges to prevent workers from falling off.

Such mezzanines can also include some type of gate that, when open, provides access to the mezzanine workspace and, when closed, prevents workers from falling off the edge. For example, some mezzanines include traditional hinge-type gates that swing open and closed. One challenge with traditional hinged gates in manufacturing facilities is that they are often just left open during work hours for convenience. As one consequence of leaving hinge gates open, the hosting facility is often cited for safety violations by regulatory agencies such as, for example, OSHA. Even more consequential, hosting facilities are liable for injuries resulting from mezzanine gates being left open.

As another example, some mezzanines employ overhead doors in place of gates. One challenge with overhead doors is that their enclosed frame restricts the size (i.e. height) of materials and equipment that can be loaded onto and off of the mezzanine. Traditional sliding gates are also employed in many mezzanines. However, these types of gates occupy a great deal of valuable workspace in the facility and, like overhead doors, often restrict the size of materials and equipment that can be loaded onto and off of the hosting mezzanine and can also restrict access to the product moving on the assembly line.

### SUMMARY

What is needed, therefore, is a gate that cannot be left open when it should be closed. What is also needed is a gate that is less restrictive in terms of the size and shape of materials loaded onto and off of the hosting workspace and less restrictive with respect to the worker's access to products moving past the mezzanine.

The present invention overcomes the problems associated with the prior art by providing a collapsible safety gate. The safety gate can be mounted to an edge of a mezzanine platform and coupled between existing safety rails. The gate can collapse into a receiver and, therefore, does not interfere with access to the workspace on, over, or adjacent the mezzanine.

An example collapsible gate includes a first side column, a second side column, a collapsible barrier, and a powertrain. The first side column has a first upper portion and a first lower portion, and the second side column has a second upper portion and a second lower portion. The collapsible barrier assembly is disposed between the first side column and the second side column. The collapsible barrier assembly has a first portion movably coupled to the first side column and an opposite second portion movably coupled to the second side column. The collapsible barrier assembly can be configured to transition between a collapsed position and a raised position. The receiver can be disposed between the first side column and the second side column, and can be configured to receive at least a portion of the collapsible barrier assembly when the collapsible barrier assembly is in the collapsed position. The receiver can have a first end coupled to the first lower portion of the first side column and an opposite second end coupled to the second lower portion of the second side column. The powertrain can be configured to transmit mechanical power to the collapsible barrier assembly, to facilitate transitioning the collapsible barrier assembly between the collapsed position and the raised position.

The example collapsible gate can further include a bracket coupled to the receiver. The bracket can be configured to attach the receiver to an edge of a raised platform, with at least a portion of the receiver being disposed below a top surface of the raised platform. The bracket can include an upright surface, configured to abut a facing surface of the raised platform, and a transverse surface configured to extend over an adjacent portion of the top surface of the raised platform.

In an example collapsible gate, the receiver can include an upper edge extending between the first side column and the second side column. The collapsible barrier can include a top guard extending transversely between the first side column and the second side column. The top guard can be disposed above the upper edge of the receiver when the collapsible barrier is in the raised position, and the top guard can be disposed below the upper edge of the receiver when the collapsible barrier is in the collapsed position.

The example collapsible barrier can include a first intermediate guard disposed below the top guard. The collapsible barrier can also include a first collapsible tensile support coupled between the top guard and the first intermediate guard. The first collapsible tensile support can support at least a portion of the weight of the first intermediate guard when the collapsible barrier is in the raised position. The first collapsible tensile support can include a first linkage, having a first end and an opposite second end, and a second linkage having a first end and an opposite second end. The first end of the first linkage can be hingably coupled to the top guard rail, and the second end of the first linkage can be hingably coupled to the first end of the second linkage. The second end of the second linkage can be hingably coupled to the first intermediate guard. The collapsible tensile support can include an angle limiting feature configured to limit an angle between the first linkage and the second linkage to less than 180 degrees. The angle limiting feature can be an integral part of at least one of the first linkage and the second linkage.

In an example collapsible gate, the powertrain can include a drive shaft, a first drive transfer, a first rotary guide, and a first drive loop. The drive shaft can have a first end disposed at a bottom the first side column and an opposite second end disposed at a bottom of the second side column. The first drive transfer can be coupled to the drive shaft adjacent the first end of the drive shaft, and the first rotary guide can be supported by the first side column above the first drive transfer. The first drive loop can be disposed around the first drive mechanism and the first rotary guide. The collapsible barrier can includes a top guard extending substantially horizontally between the first side column and the second side column, and a first end of the top guard can be fixably coupled to the first drive loop. In a more particular example collapsible gate, the first drive transfer can be a first sprocket, the rotary guide can be a second sprocket, and the first drive loop can be a chain.

In a more particular example collapsible gate, the powertrain can further include a second drive transfer, a second rotary guide, and a second drive loop. The second drive transfer can be coupled to the drive shaft adjacent the second end of the drive shaft, and the second rotary guide can be supported by the second column above the second drive transfer. The second drive loop can be disposed around the second drive transfer and the second rotary guide. The second end of the top guard, opposite the first end of the top guard, can be fixably coupled to the second drive loop. Even more particularly, the first drive transfer can be a first sprocket, the first rotary guide can be a second sprocket, the first drive loop can be a first chain, the second drive transfer can be a third sprocket, the second rotary guide can be a fourth sprocket, and the second drive loop can be a second chain.

In an example collapsible gate, the powertrain can include a motor mechanically coupled to the drive shaft, and the example collapsible gate can additionally include control circuitry. The control circuitry can be configured to selectively drive the motor in a first direction and a second direction. Driving the motor in a first direction can displace a portion of the first chain and a portion of the second chain a predetermined distance upward. Driving the motor in a second direction, opposite the first direction, can displace the portion of the first chain and the portion of the second chain the predetermined distance downward.

An example collapsible gate can additionally include control circuitry. The control circuitry, responsive to input from a user, can be operative to selectively energize the motor to transition the collapsible barrier assembly between the collapsed position and the raised position.

An example collapsible gate can additionally include an alarm. The alarm can be operative to provide an alert when the gate has been lowered for an undesirably long period of time. For example, the alarm can be operative to determine when the collapsible barrier has been transitioned from the raised position. The alarm can also be configured to monitor an amount of time that elapses after the collapsible barrier has been transitioned from the raised position and not returned to the raised position. Then, the alarm can generate an alarm signal when the amount of time exceeds a predetermined amount of time.

An example collapsible gate can additionally include a first connector and a second connector. The first connector can be disposed and configured to couple the first side column to a first safety rail on a first side of the collapsible gate. The second connector can be disposed and configured to couple the second side column to a second safety rail on a second side of the collapsible gate.

An example working platform includes a platform and a safety gate. The platform has a top surface terminating at a side edge, and the platform additionally includes a facing surface extending downward from the first side edge. The safety gate can be mounted to the side edge, and can include a first side column, a second side column, a collapsible barrier assembly, a receiver, a powertrain, and a mounting bracket. The collapsible barrier is disposed between the first side column and the second side column. The collapsible barrier assembly can have a first portion movably coupled to the first side column and an opposite second portion movably coupled to the second side column. The collapsible barrier assembly can be configured to transition between a collapsed position and a raised position. The receiver can be disposed between the first side column and the second side column. The receiver can be configured to receive at least a portion of the collapsible barrier assembly when the collapsible barrier assembly is in the collapsed position. The receiver can have a first end coupled to a lower portion of the first side column and an opposite second end coupled to a lower portion of the second side column. The powertrain can be configured to transmit mechanical power to the collapsible barrier assembly to facilitate transitioning the collapsible barrier assembly between the collapsed position and the raised position. The bracket can attach the safety gate to the first side edge of the platform.

In the example working platform, the collapsible barrier can includes a top rail, and the top rail of the collapsible barrier can be disposed below the top surface of the platform when the collapsible barrier is in the collapsed position. The example platform can additionally include a first safety railing fixed along a first portion of the side edge of the platform adjacent a first side of the safety gate. A portion of the first safety railing can be coupled to the first side column of the safety gate. The example working platform can additionally include a second safety railing fixed along a second portion of the side edge of the platform adjacent a second side of the safety gate. A portion of the second safety railing can be coupled to the second side column of the safety gate.

### BRIEF DESCRIPTION OF THE DRAWINGS

The present invention is described with reference to the following drawings, wherein like reference numbers denote substantially similar elements:

FIG. 1A is a perspective view of a collapsible gate mounted to a mezzanine and in a raised position;

FIG. 1B is a perspective view of the collapsible gate mounted to the mezzanine of FIG. 1A in a collapsed position;

FIG. 2 is a rear perspective view of the collapsible gate of FIG. 1A in a raised position;

FIG. 3 is a front perspective view of the collapsible gate of FIG. 1A in a collapsed position;

FIG. 4 is a side view of the collapsible gate of FIG. 1A mounted to the mezzanine;

FIG. 5 is a front perspective view of the powertrain and collapsible barrier assembly of the collapsible gate of FIG. 1A;

FIG. 6 is an exploded perspective view of a collapsible tensile support of the collapsible barrier assembly of FIG. 5;

FIG. 7A is a front view of the collapsible gate of FIG. 1A in a raised position;

FIG. 7B is a front view of the collapsible gate of FIG. 1A in an early stage of transitioning from a raised position to a collapsed position;

FIG. 7C is a front view of the collapsible gate of FIG. 1A in a later stage of transitioning from a raised position to a collapsed position;

FIG. 7D is a front view of the collapsible gate of FIG. 1A in a collapsed position; and

FIG. 8 is a diagram showing the electrical system of the collapsible gate of FIG. 1A.

### DETAILED DESCRIPTION

The present invention overcomes the problems associated with the prior art, by providing a powered gate that is less restrictive with respect to access to and from a mezzanine. In the following description, numerous specific details are set forth (e.g., motor types, fastener types, etc.) in order to provide a thorough understanding of the invention. Those skilled in the art will recognize, however, that the invention may be practiced apart from these specific details. In other instances, details of well-known manufacturing practices (e.g., routine optimization, sheet metal bending/drilling, etc.) and components have been omitted, so as not to unnecessarily obscure the present invention.

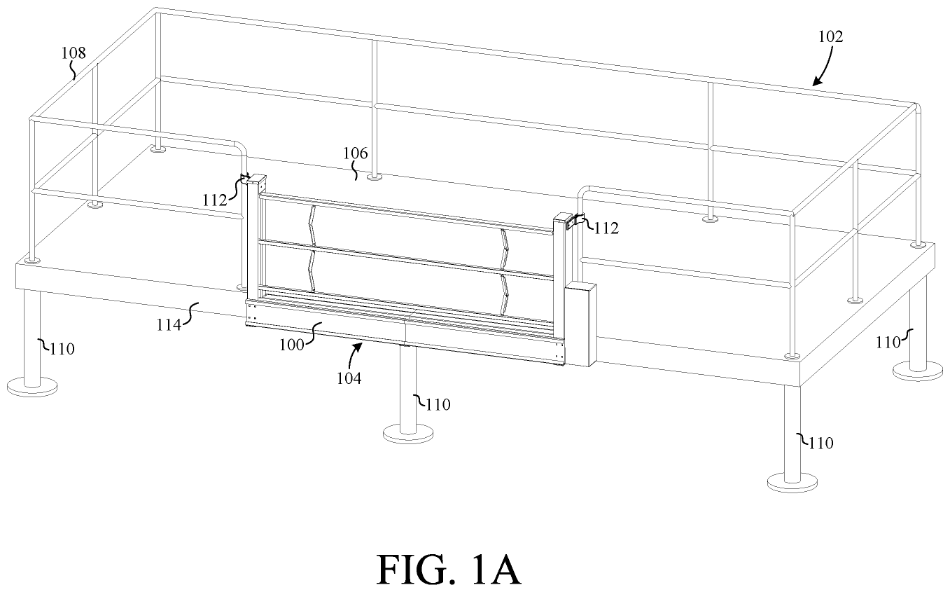

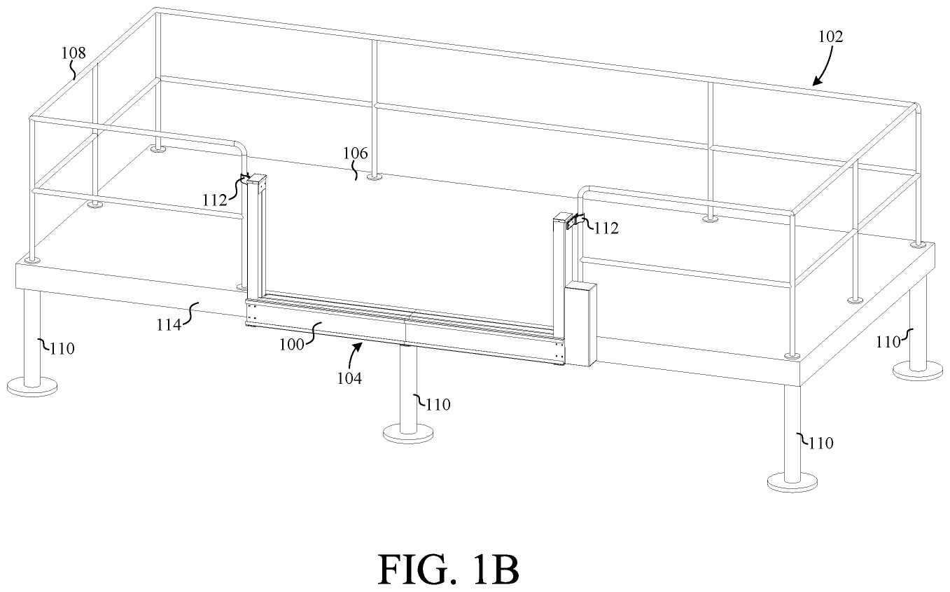

FIGS. 1A and 1B show perspective views of a gate 100 mounted at an entrance of an example mezzanine 102 that might be present in a factory setting to provide an elevated workspace. More specifically, FIGS. 1A and 1B show gate 100 in a closed position and an open position, respectively. In the closed position, as shown in FIG. 1A, gate 100 functions as a safety guardrail, which prevents workers from falling off of mezzanine 102. In the open position, as shown in FIG. 1B, gate 100 allows people, tools, and/or other materials to be loaded onto, and off of, mezzanine 102.

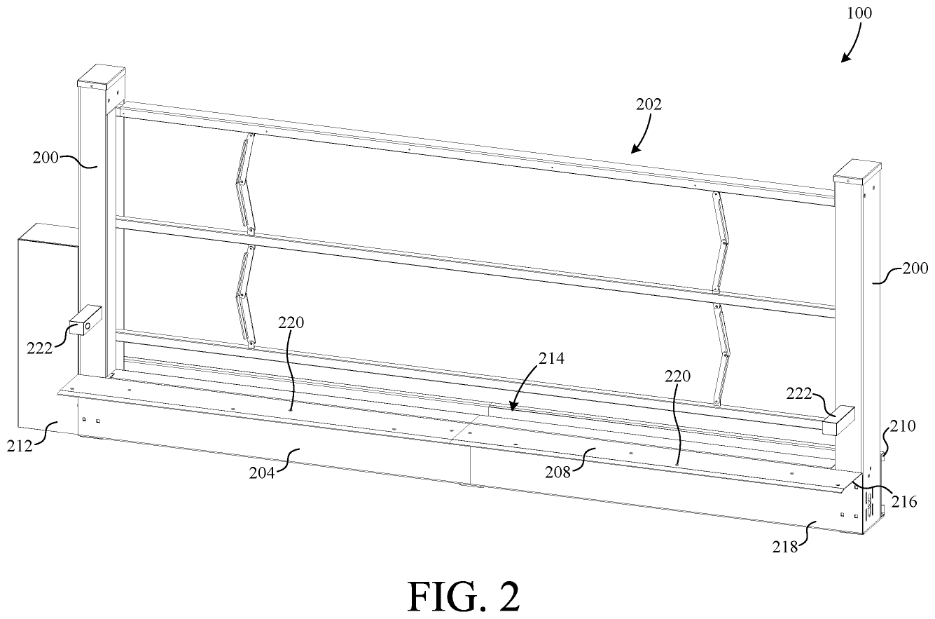

Mezzanine 102 includes an entrance 104, a main platform 106, a plurality of guardrails 108, and a plurality of legs 110. Entrance 104 is located on the front of mezzanine 102 to provide a passage through which workers, tools, and materials pass when loaded onto, and off of, platform 106. Guardrails 108 are mounted around the peripheral edges of platform 106 as a safety precaution to prevent workers from falling off of platform 106. Workers standing on platform 106 access can access large workpieces (e.g., campers, trailers, manufactured homes, etc.) passing by any side of mezzanine 102. Legs 110 are disposed below platform 106 to support platform 106 in an elevated position over an underlying factory floor. Gate 100 is attached to guardrails 108 via a set of brackets 112 and is also mounted to an edge 114 of platform 106 as will be described below in greater detail with reference to FIG. 2.

The operation of gate 100 is summarized in the following example. When a worker decides to board mezzanine 102, the worker first actuates gate 100 by either a remotely controlled switch or a switch directly wired to gate 100. Upon actuation, gate 100 transitions to an open position (FIG. 1B) and the worker is free to pass through entrance 104. Once the worker is safely standing on platform 106, the worker actuates gate 100 again, thereby causing it to transition to a closed position (FIG. 1A). Optionally, gate 100 may be configured to close automatically after being opened. For example, gate 100 may be configured to close after some predetermined time duration passes since it was last opened.

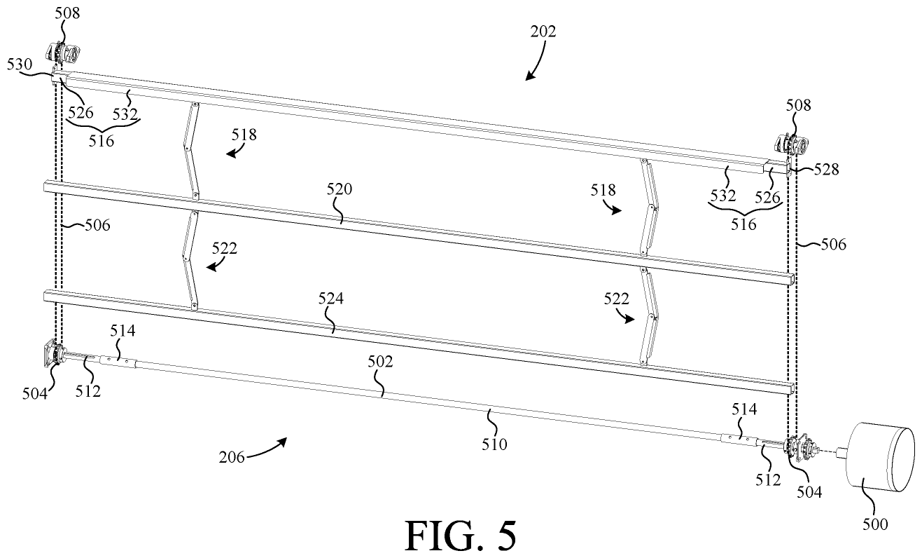

FIG. 2 is a rear perspective view of gate 100 removed from mezzanine 102 and in a closed position. Gate 100 includes two side columns 200, a collapsible barrier assembly 202, a receiver 204, a powertrain 206, a bracket 208, and a bumper 210. Each of side columns 200 extends substantially vertically from a respective side end of receiver 204 to, together, support and guide collapsible barrier assembly 202 along a substantially vertical path. Collapsible barrier assembly 202 is coupled to powertrain 206, which is disposed within a plurality of housing panels and, therefore, not visible in FIG. 2. For example, an electric motor and control circuitry of powertrain 206 are disposed within a housing box 212, which is mounted to one of side columns 200. Details of powertrain 206 are shown and described below with reference to upcoming FIG. 5. Receiver 204 defines a recess 214, into which collapsible barrier assembly 202 collapses when gate 100 is open. Bracket 208 is coupled to the rear of receiver 204 and is configured to engage edge 114 of mezzanine 102. Bumper 210 is mounted to the front of receiver 204 to absorb potential impact from loading equipment such as, for example, fork lifts. An optical detector 222 is disposed to detect any obstructions, which might interfere with the opening of gate 100.

In the example embodiment, side columns 200, receiver 204, bracket 208, bumper 210, and housing box 212 are formed from sheet metal panels that are cut, bent, and fastened together by traditional sheet metal structure fabrication processes. It should be understood, however, that alternate materials and structures may be substituted for the various sheet metal structures shown. For example, solid steel beams may be substituted for the otherwise hollow sheet metal box configuration of columns 200.

As shown, bracket 208 includes an interior transverse surface 216, which in this example is substantially horizontal, and an interior facing surface 218, which in this example is substantially vertical). Surfaces 216 and 218 are configured to engage the horizontal top surface and vertical side surface, respectively, of edge 114 of mezzanine 102. Accordingly, surfaces 216 and 218 form approximately a ninety degree angle therebetween. Transverse surface 216 defines a plurality of apertures 220 configured to receive fasteners (e.g., screws, bolts, etc.) used to mount bracket 208 to the top surface of platform 106, adjacent edge 114.

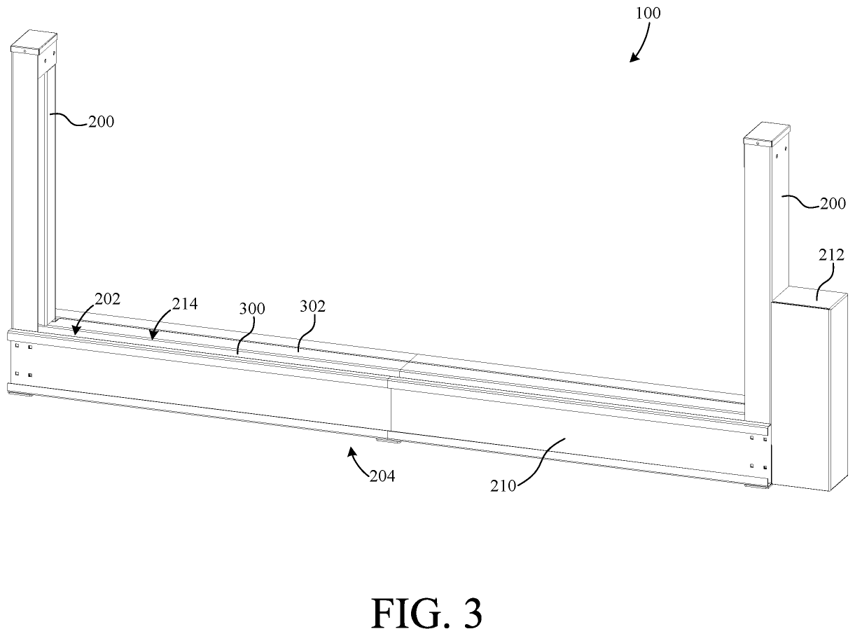

FIG. 3 is a front perspective view of gate 100 removed from mezzanine 102 and in an open position. In this open position, collapsible barrier assembly 202 is completely collapsed into recess 214, such that the top surface 300 of collapsible barrier assembly 202 is substantially level with the top surface of a sill 302 of receiver 204. Optionally, top surface 300 of collapsible barrier assembly 202 may be slightly lower than the top surface of sill 302. In either configuration, workers passing through gate 100 are not in danger of tripping over collapsible barrier assembly 202 when gate 100 is in the open position, because it does not protrude above the top surface of sill 302. Similarly, top surface 300 of collapsible barrier assembly 202 will not interfere with or be damaged by items being loaded or unloaded from mezzanine 102 by, for example, a forklift or other machinery.

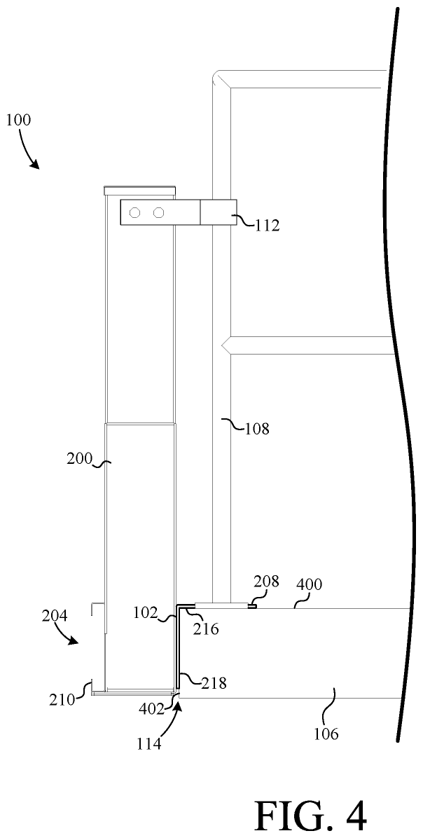

FIG. 4 shows a side plan view of gate 100 mounted to mezzanine 102. Interior transverse surface 216 of bracket 208 engages the top surface 400 of platform 106, while interior facing surface 218 of bracket 208 engages the vertical side surface 402 of platform 106. Although not shown, bracket 208 is also fastened to edge 114 by, for example, screws or any other suitable means. When gate 100 is mounted to mezzanine 102, columns 200, collapsible barrier assembly 202 (not visible), receiver 204, and powertrain 206 (not visible) are all disposed adjacent edge 114 rather than directly above platform 106.

FIG. 5 is a perspective view of powertrain 206 and collapsible barrier assembly 202 of gate 100. Powertrain 206 is mechanically coupled to supply power to collapsible barrier assembly 202 to facilitate the automatic lifting and lowering of collapsible barrier assembly 202.

Powertrain 206 includes a motor 500, a driveshaft 502, a set of drive transfers 504, a set of drive loops 506, and a set of rotary guides 508. In this example, powertrain 206 is a chain-drive mechanical system, wherein drive transfers 504 are sprocket assemblies fixed to driveshaft 502, drive loops 506 are closed-loop chains, and rotary guides 508 are idler sprocket assemblies. Alternatively, a belt-drive system may be substituted for the chain-drive system. In such a case, drive transfers 504 would be drive pulleys (e.g., toothed pulleys, friction pulleys, etc.) fixed to driveshaft 502, drive loops 506 would be belts, and rotary guides 508 would be idler pulleys. Motor 500 is coupled to driveshaft 502 via a coupler (not shown) and, therefore, supplies 1:1 rotational power directly to driveshaft 502. Optionally, a transmission (e.g., geared transmission, sprocket/chain transmission, etc.) may be interposed between motor 500 and driveshaft 502 to alter torque and angular velocity outputs of driveshaft 502 compared to motor 500. Driveshaft 502 is configured to transfer power, supplied by motor 500, directly to both drive sprocket assemblies 504 simultaneously. Drive shaft includes an intermediate section 510 interposed between two end sections 512. Each end section 512 is fixed to an opposite end of intermediate section 510 via a respective shaft coupler 514, such that there is substantially no relative motion between sections 510 and 512 when powertrain 206 is driven. Each end section 512 is also keyed, so that there is substantially no relative motion between end sections 512 and drive sprocket assemblies 504 when powertrain 206 is driven. Accordingly, each section 512 defines a keyseat and each sprocket assembly 504 defines a complementary keyway. Each keyseat aligns with a respective keyway to receive a complementary key inserted therebetween. Each drive sprocket assembly 504 includes a sprocket rotatably coupled to a single 4-bolt flange, which bolts to an interior sidewall of a respective one of columns 200. Each of idler sprocket assemblies 508 includes a sprocket rotatably interposed between two flanges, each flange being configured to bolt to respective opposing interior sidewalls of a respective column 200. Each idler sprocket assembly 508 is aligned and fixed directly above a respective one of drive sprocket assemblies 504. Each one of chains 506 is simultaneously disposed around a respective one of drive sprocket assemblies 504 and the respective idler sprocket assembly 508 that is disposed directly above it. Accordingly, when driveshaft 502 is rotated by motor 500, both chains 506 are driven simultaneously at the same angular velocity.

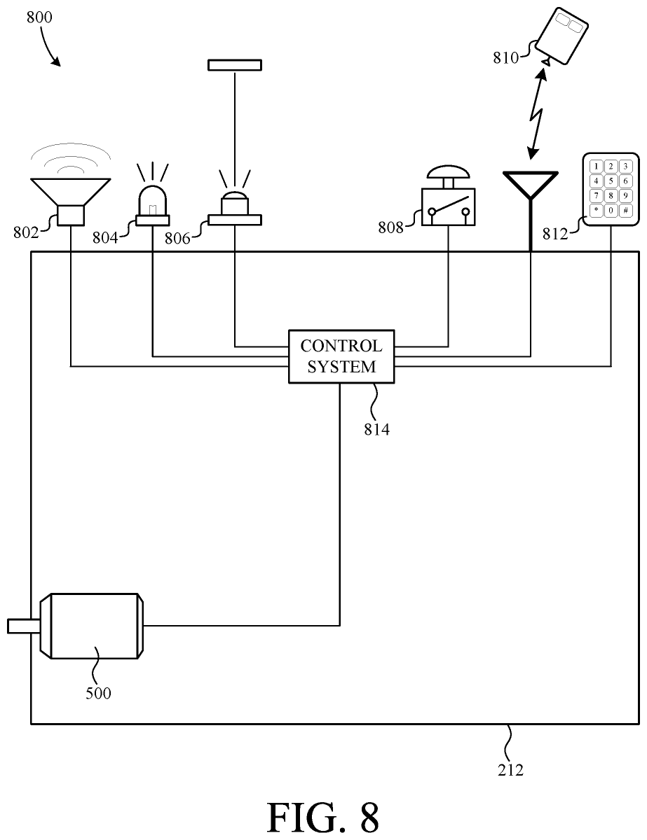

Collapsible barrier assembly 202 includes a top guard 516, a first set of collapsible tensile supports 518, an intermediate guard 520, a second set of collapsible tensile supports 522, and a bottom guard 524. Top guard 516 includes a horizontal metal rail 526 having a first end 528 fixed to a first one of chains 506 and an opposite second end 530 fixed to the second one of chains 506. With rail 526 fixed to chains 506, the elevation of beam 526 is altered by rotating driveshaft 502. That is, rotating driveshaft 502 in one direction lowers rail 526, and rotating driveshaft 502 in the opposite direction raises rail 526. As will be described with reference to FIG. 8, the upper and lower limits of rail 526 are adjustable through a control system that is electrically connected to motor 500.

Top guard 516 further includes an optional cover 532 which, in this example embodiment, is a section of U-channel stock fixed to the top surface of rail 526. Cover 532 has a slightly wider top surface so that it covers the opening of recess 214 of receiver 204 when collapsible barrier assembly 202 is collapsed therein.

Tensile supports 518 and 522 are configured to extend and suspend intermediate guard 520 and bottom guard 524, respectively, when collapsible barrier assembly 202 is in the raised position. Tensile supports 518 and 522 are also configured to collapse when collapsible barrier assembly 202 is in the lowered position. Each of supports 518 is hingably coupled to the bottom of top guard 516 and hingably coupled to the top of intermediate guard 520. Each of supports 522 is hingably coupled to the bottom of intermediate guard 520 and hingably coupled to the top of bottom guard 524.

Tensile supports 518 and 522 are also each configured so that they cannot fully extend to 180 degrees when collapsible barrier assembly 202 is in a raised position. As a result, tensile supports 518 are prevented from locking into an extended position and will always collapse under compression. Intermediate guard 520 and bottom guard 524 are substantially horizontal metal rails that are suspended from tensile supports 518 and 522, respectively. In this example, the open ends of intermediate guard 520 and bottom guard 524 are free floating and not connected to chains 506.

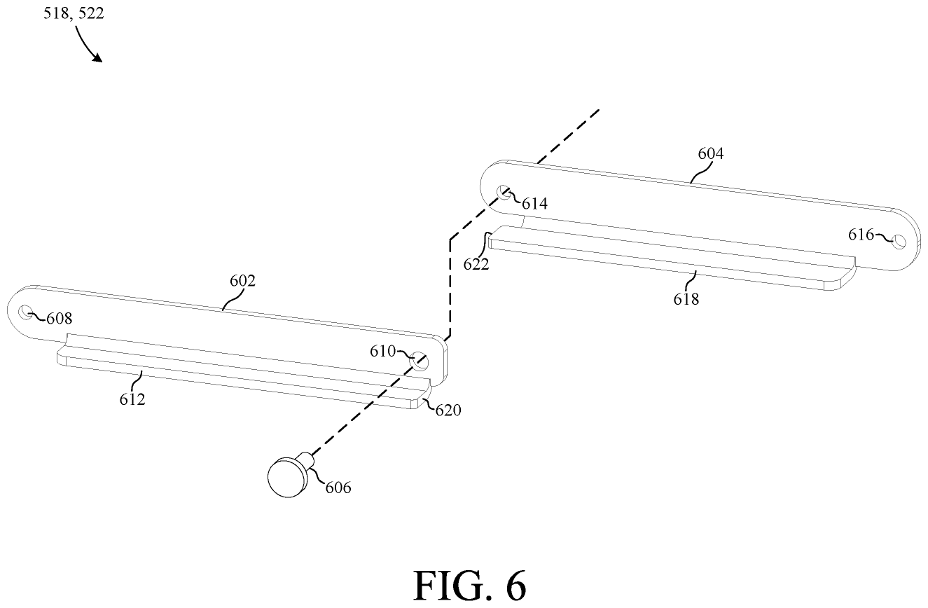

FIG. 6 is a perspective view of one of tensile supports 518 and 522 exploded along an axis 600. In the example embodiment, all four tensile supports 518 and 522 are identical assemblies. That is, each of the four tensile supports 518 and 522 include a first linkage 602 hingably coupled to a second linkage 604 via a hinge pin 606. Linkage 602 defines a first aperture 608, a second aperture 610, and a lip 612. Aperture 608 is configured to receive a hinge pin that is used to pin linkage 602 to the bottom of a guard rail (i.e., top guard 516 or intermediate guard 520). Aperture 610 is configured to receive hinge pin 606 to facilitate the hinged attachment of linkage 602 to linkage 604. Linkage 604 defines a first aperture 614, a second aperture 616, and a lip 618. Aperture 614 is configured to receive a hinge pin that is used to pin linkage 604 to the top of a guard rail (i.e., intermediate guard 520 or bottom guard 524). Aperture 616 is configured to receive hinge pin 606 to facilitate the hinged attachment of linkage 602 to linkage 604. Lip 612 defines a surface 620 that is adapted to abut a complementary surface 622 of lip 618 when linkages 602 and 604 are pivoted away from one another about hinge pin 606. The abutment between surfaces 620 and 622 limits the angle between linkages 602 and 604 by preventing the angle from reaching 180 degrees when tensile supports 518 and 522 are fully extended. In other words, lips 612 and 618, together, function as a stopper to prevent full extension of tensile supports 518 and 522. As a result, tensile supports 518 and 522 inherently collapse when aperture 608 of linkage 602 is urged toward aperture 614 of linkage 604.

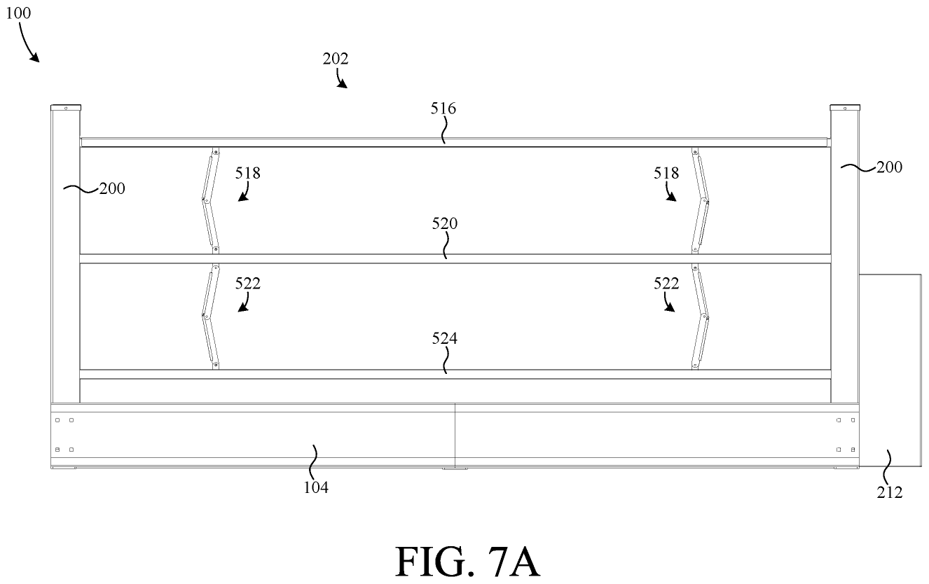

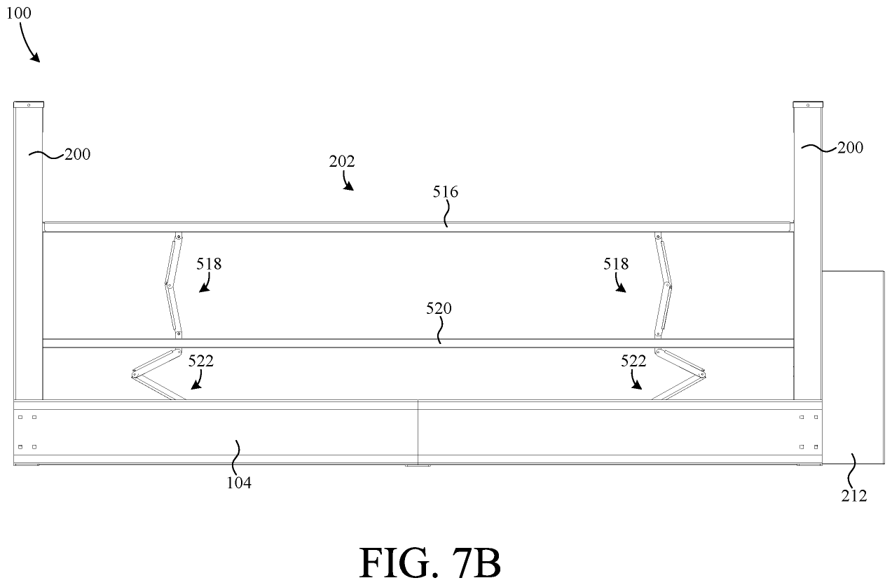

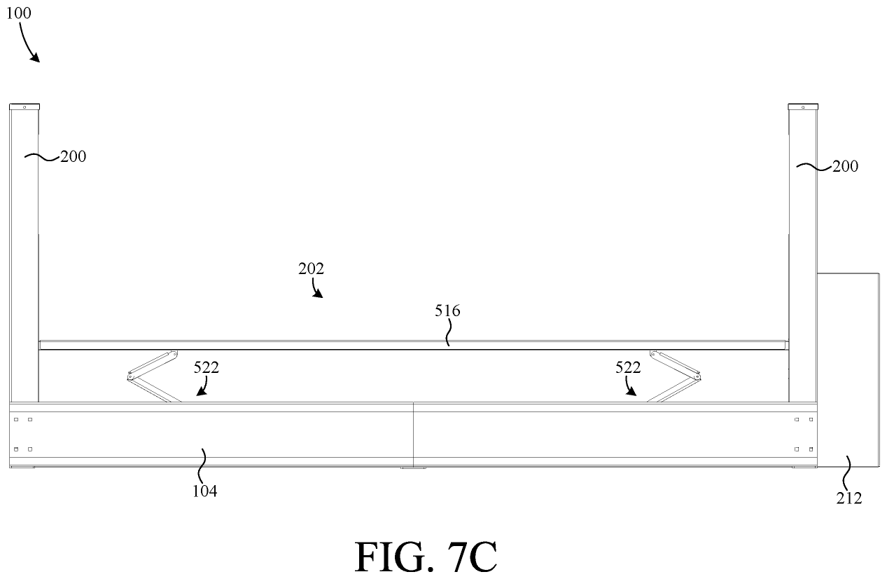

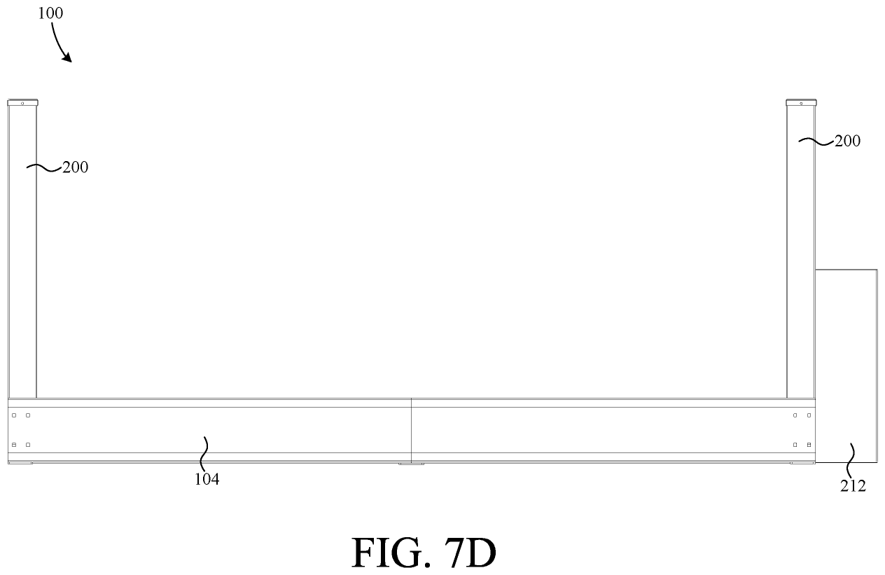

The transition of collapsible barrier assembly 202 from a fully raised position to a fully collapsed position is summarized, as follows, with reference to FIGS. 7A-7D. In the raised position illustrated in FIG. 7A, top guard 516 is disposed at the upper most limit, wherein tensile supports 518 and 522 are fully extended. In this raised position, the combined weight of tensile supports 518, intermediate guard 520, tensile supports 522, and bottom guard 524 is completely supported by top guard 516. Upon actuation of motor 500, top guard 516 begins to move downward and causes bottom guard 524 to enter recess 214, where its weight is supported by receiver 204, and tensile supports 522 begin to collapse as shown in FIG. 7B. At this point, most of the weight still supported by top guard 516 is from intermediate guard 520 and tensile supports 518. As top guard 516 continues to advance downward as shown in FIG. 7C, intermediate guard 520 enters recess 214, following bottom guard 524, where the weight of intermediate guard 520 becomes supported by receiver 204, and tensile supports 518 begin to collapse. At this point, top guard 516 is supporting only its own weight and a small amount of the weight of tensile supports 518. As top guard 516 continues to advance downward, it enters recess 214 and continues until the top surface of top guard 516 is below, or level with, the top surface of receiver 204, as shown if FIG. 7D. At this point, gate 100 is in an open position, wherein workers, materials, and tools can pass therethrough.

FIG. 8 is a diagram illustrating an example electrical system 800 of gate 100, which includes motor 500, one or more audio outputs 802, one or more visual outputs 804, one or more proximity sensors 806, one or more manual switches 808, a wireless controller 810, and a user interface 812, all connected to a control system 814. Audio output 802 includes, for example, a speaker that outputs various audio indicators. For example, when the gate 100 has been in an open position for more than a predetermined time, audio output 802 may output an alarm to remind nearby workers that gate 100 has been left open. Visual output 804 includes, for example, a blinking light that flashes when the gate 100 is open, has been in an open position for more than a predetermined time, is out of order, or for any reason that justifies alerting nearby workers that gate 100 needs attention. Proximity sensor 806 includes, for example, an optical eye that senses when the passage through gate 100 is obstructed. For example, if an object (e.g., worker, tool, material, etc.) is inadvertently left in the path of collapsible barrier assembly 202, it will be observed by sensor 806 and control system will prevent motor 500 from actuating, even if a worker tries to actuate it. Manual switches 808 represent any type of hardwired switch and/or control button on gate 100. For example, switches 808 may include an emergency shut-down switch for gate 100, a motor actuation switch, a power switch, etc. Wireless controller 810 represents any type of wireless controller for controlling the actuation of gate 100 remotely, which might include, for example, a dedicated wireless controller, a mobile hand-held device, and so on. Instructions sent to control system 814 remotely may include actuation instructions such as, for example, raise gate, lower gate, stop gate, etc. User interface 812 represents any type of device(s) facilitating information exchange between a user and control system 814. For example, a user may input the vertical range that top guard 516 moves between when actuated through interface 812. In other words, the user may define the uppermost height limit and/or the lowermost height limit that top guard 516 moves between. Other information may be communicated through user interface 812 as well. For example, user interface 812 may include an ID scanner or a number pad so that only those granted access to mezzanine 102 may open gate 100. Control system 814 facilitates various control functions such as, for example, automatically closing gate 100 after a predetermined time duration has passed since gate 100 was last opened. As another example, control system 814 can monitor the power consumed by motor 500 to identify gate obstructions, malfunctions, and so on.

The description of particular embodiments of the present invention is now complete. Many of the described features may be substituted, altered or omitted without departing from the scope of the invention. For example, alternate structures (e.g., I-beams, solid columns, etc.), may be substituted for the sheet metal structural components. As another example, alternate tensile supports (e.g., flexible cables, chains, etc.), may be substituted for the collapsible tensile supports. As yet another example, the example barrier assembly can include a greater or lesser number of guards (e.g., transverse rails). As yet another example, the looped drive systems (e.g., belt, chain, etc.) can be replaced with a linear drive system that might include for example, a biasing member (a coil spring, retractable cable, and so on) to maintain the gate in one position (e.g., open or closed), and a drive mechanism (e.g., a cable, worm drive, and so on) that would pull or push the gate into the opposite position (e.g., closed or open) against the restoring force of the biasing member. These and other deviations from the particular embodiments shown will be apparent to those skilled in the art, particularly in view of the foregoing disclosure.

We claim:

1. A collapsible gate comprising:
a first side column having a first upper portion and a first lower portion;
a second side column having a second upper portion and a second lower portion;
a collapsible barrier assembly disposed between said first side column and said second side column, said collapsible barrier assembly having a first portion movably coupled to said first side column and an opposite second portion movably coupled to said second side column, said collapsible barrier assembly being configured to transition between a collapsed position and a raised position;
a receiver disposed between said first side column and said second side column, said receiver being configured to receive at least a portion of said collapsible barrier assembly when said collapsible barrier assembly is in said collapsed position, said receiver having a first end coupled to said first lower portion of said first side column and an opposite second end coupled to said second lower portion of said second side column; and
a powertrain configured to transmit mechanical power to said collapsible barrier assembly to facilitate transitioning said collapsible barrier assembly between said collapsed position and said raised position.

2. The collapsible gate of claim 1, further comprising a bracket coupled to said receiver, said bracket being configured to attach said receiver to an edge of a raised platform with at least a portion of said receiver being disposed below a top surface of said raised platform.

3. The collapsible gate of claim 2, wherein said bracket includes:
an upright surface configured to abut a facing surface of said raised platform; and
a transverse surface configured to extend over an adjacent portion of said top surface of said raised platform.

4. The collapsible gate of claim 1, wherein:
said receiver includes an upper edge extending between said first side column and said second side column;
said collapsible barrier includes a top guard extending transversely between said first side column and said second side column;
said top guard is disposed above said upper edge of said receiver when said collapsible barrier is in said raised position; and
said top guard is disposed below said upper edge of said receiver when said collapsible barrier is in said collapsed position.

5. The collapsible gate of claim 4, wherein:
said collapsible barrier includes a first intermediate guard disposed below said top guard;
said collapsible barrier includes a first collapsible tensile support coupled between said top guard and said first intermediate guard; and
said first collapsible tensile support supports at least a portion of the weight of said first intermediate guard when said collapsible barrier is in said raised position.

6. The collapsible gate of claim 5, wherein:
said first collapsible tensile support includes a first linkage having a first end and an opposite second end;
said first collapsible tensile support includes a second linkage having a first end and an opposite second end;
said first end of said first linkage is hingably coupled to said top guard;
said second end of said first linkage is hingably coupled to said first end of said second linkage;
said second end of said second linkage is hingably coupled to said first intermediate guard; and
said collapsible tensile support includes an angle limiting feature configured to limit an angle between said first linkage and said second linkage to less than 180 degrees.

7. The collapsible gate of claim 6, wherein said angle limiting feature is an integral part of at least one of said first linkage and said second linkage.

8. The collapsible gate of claim 1, wherein said powertrain further includes:
a drive shaft having a first end disposed at a bottom said first side column and an opposite second end disposed at a bottom of said second side column;
a first drive transfer coupled to said drive shaft adjacent said first end of said drive shaft;
a first rotary guide supported by said first side column above said first drive transfer; and
a first drive loop disposed around said first drive mechanism and said first rotary guide; and wherein
said collapsible barrier includes a top guard extending substantially horizontally between said first side column and said second side column; and
a first end of said top guard is fixably coupled to said first drive loop.

9. The collapsible gate of claim 8, wherein:
said first drive transfer is a first sprocket;
said rotary guide is a second sprocket; and
said first drive loop is a chain.

10. The collapsible gate of claim 8, wherein said powertrain further includes:
a second drive transfer coupled to said drive shaft adjacent said second end of said drive shaft;
a second rotary guide supported by said second column above said second drive transfer; and
a second drive loop disposed around said second drive transfer and said second rotary guide; and wherein
a second end of said top guard, opposite said first end of said top guard, is fixably coupled to said second drive loop.

11. The collapsible gate of claim 10, wherein:
said first drive transfer is a first sprocket;
said first rotary guide is a second sprocket;
said first drive loop is a first chain;
said second drive transfer is a third sprocket;
said second rotary guide is a fourth sprocket; and
said second drive loop is a second chain.

12. The collapsible gate of claim 10, wherein said powertrain includes a motor mechanically coupled to said drive shaft.

13. The collapsible gate of claim 12, further comprising control circuitry configured to:
drive said motor in a first direction thereby displacing a portion of said first chain and a portion of said second chain a predetermined distance upward; and
drive said motor in a second direction, opposite said first direction, thereby displacing said portion of said first chain and said portion of said second chain said predetermined distance downward.

14. The collapsible gate of claim 1, further comprising:
a motor coupled to said drivetrain; and
control circuitry responsive to input from a user and operative to selectively energize said motor to transition said collapsible barrier assembly between said collapsed position and said raised position.

15. The collapsible gate of claim 14, further comprising an alarm operative to:
determine when said collapsible barrier has been transitioned from said raised position;
monitor an amount of time that elapses after said collapsible barrier has been transitioned from said raised position and not returned to said raised position; and
generate an alarm signal when said amount of time exceeds a predetermined amount of time.

16. The collapsible gate of claim 1, further comprising:
a first connector disposed and configured to couple said first side column to a first safety rail on a first side of said collapsible gate; and
a second connector disposed and configured to couple said second side column to a second safety rail on a second side of said collapsible gate.

17. A working platform comprising:
a platform having a top surface terminating at a side edge, said platform additionally including a facing surface extending downward from said first side edge;
a safety gate mounted to said side edge, said safety gate comprising
a first side column,
a second side column,
a collapsible barrier assembly disposed between said first side column and said second side column, said collapsible barrier assembly having a first portion movably coupled to said first side column and an opposite second portion movably coupled to said second side column, said collapsible barrier assembly being configured to transition between a collapsed position and a raised position,
a receiver disposed between said first side column and said second side column, said receiver being configured to receive at least a portion of said collapsible barrier assembly when said collapsible barrier assembly is in said collapsed position, said receiver having a first end coupled to a lower portion of said first side column and an opposite second end coupled to a lower portion of said second side column,
a powertrain configured to transmit mechanical power to said collapsible barrier assembly to facilitate transitioning said collapsible barrier assembly between said collapsed position and said raised position, and
a bracket attaching said safety gate to said first side edge of said platform.

18. The working platform of claim 17, wherein:
said collapsible barrier includes a top rail; and
said top rail of said collapsible barrier is disposed below said top surface of said platform when said collapsible barrier is in said collapsed position.

19. The working platform of claim 18, further comprising a first safety railing fixed along a first portion of said side edge of said platform adjacent a first side of said safety gate, and wherein a portion of said first safety railing is coupled to said first side column of said safety gate.

20. The working platform of claim 19, further comprising a second safety railing fixed along a second portion of said side edge of said platform adjacent a second side of said safety gate, and wherein a portion of said second safety railing is coupled to said second side column of said safety gate.
